(19) United States
(12) Patent Application Publication
(10) Pub. No.: US 2024/0389190 A1
(43) Pub. Date: Nov. 21, 2024

(54) TECHNIQUES FOR BANDWIDTH PART INTERACTION WITH CELL DISCONTINUOUS RECEPTION AND CELL DISCONTINUOUS TRANSMISSION

(71) Applicant: QUALCOMM Incorporated, San Diego, CA (US)

(72) Inventors: Ahmed Attia ABOTABL, San Diego, CA (US); Diana MAAMARI, San Diego, CA (US); Irmak AYKIN, Escondido, CA (US)

(21) Appl. No.: 18/318,201

(22) Filed: May 16, 2023

(51) Int. Cl. H04W 76/28

(52) U.S. Cl. CPC H04W 76/28

(57) ABSTRACT

Methods, systems, and devices for wireless communications are described. A network entity may operate in a discontinuous reception (DRX) and/or a discontinuous transmission (DTX) cycle. The network entity may indicate to a user equipment (UE) in control signaling that the network entity will enter a DRX and/or a DTX cycle. Some BWPs may be associated with lower energy consumption at the UE and/or the network entity. A UE configured with multiple BWPs may switch from a first BWP to a second BWP based on the network entity entering a DTX or DRX cycle. For example, the second BWP may be a default BWP or a BWP that is indicated as being associated with cell DRX or cell DTX. In some aspects, an inactivity timer at the UE that triggers switching the active BWP may be adjusted to account for cell DTX and/or cell DRX.

### FIELD OF DISCLOSURE

The present disclosure, for example, relates to wireless communication systems, more particularly to techniques for bandwidth part interaction with cell discontinuous reception and cell discontinuous transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for bandwidth part (BWP) interaction with cell discontinuous reception (DRX) and cell discontinuous transmission (DTX). For example, a user equipment (UE) may be configured with multiple BWPs. A serving network entity (e.g., a cell) may operate in a DRX and/or a DTX cycle, for example, to save power. The network entity may indicate to a UE via control signaling (e.g., via radio resource control (RRC), a medium access control (MAC) control element (MAC-CE), or downlink control information (DCI)), that the network entity will enter a DRX and/or a DTX cycle so that the UE may transmit uplink signaling to the network entity during the active periods of the DRX cycle and/or monitor for downlink signaling from the network entity during the active periods of the DTX cycle. Some BWPs may be associated with lower energy consumption at the UE and/or the network entity. A UE configured with multiple BWPs may switch from a first BWP to a second BWP based on the network entity entering a DTX or DRX cycle. For example, the second BWP may be a default BWP or a BWP that is indicated as being associated with cell DRX or cell DTX. In some aspects, an inactivity timer at the UE that triggers switching the active BWP may be adjusted to account for cell DTX. For example, the inactivity timer may be paused during the inactive durations (e.g., as the UE is not expected to receive during the inactive periods of the cell DTX cycle). In some cases, an offset may be added to the inactivity timer as the UE is not expected to receive during the inactive periods of the cell DTX cycle.

A method for wireless communications at UE is described. The method may include receiving first control signaling indicating a set of multiple BWPs for the UE, receiving, from a network entity, second control signaling indicating at least one of a DTX cycle for the network entity or a DRX cycle for the network entity, and switching an active BWP for communication between the network entity and the UE from a first BWP of the set of multiple BWPs to a second BWP of the set of multiple BWPs based on the network entity entering the DTX cycle or the DRX cycle in accordance with the second control signaling.

An apparatus for wireless communications at UE is described. The apparatus may include a processor, memory coupled with the processor, and instructions stored in the memory. The instructions may be executable by the processor to cause the apparatus to receive first control signaling indicating a set of multiple BWPs for the UE, receive, from a network entity, second control signaling indicating at least one of a DTX cycle for the network entity or a DRX cycle for the network entity, and switch an active BWP for communication between the network entity and the UE from a first BWP of the set of multiple BWPs to a second BWP of the set of multiple BWPs based on the network entity entering the DTX cycle or the DRX cycle in accordance with the second control signaling.

Another apparatus for wireless communications at UE is described. The apparatus may include means for receiving first control signaling indicating a set of multiple BWPs for the UE, means for receiving, from a network entity, second control signaling indicating at least one of a DTX cycle for the network entity or a DRX cycle for the network entity, and means for switching an active BWP for communication between the network entity and the UE from a first BWP of the set of multiple BWPs to a second BWP of the set of multiple BWPs based on the network entity entering the DTX cycle or the DRX cycle in accordance with the second control signaling.

A non-transitory computer-readable medium storing code for wireless communications at UE is described. The code may include instructions executable by a processor to receive first control signaling indicating a set of multiple BWPs for the UE, receive, from a network entity, second control signaling indicating at least one of a DTX cycle for the network entity or a DRX cycle for the network entity, and switch an active BWP for communication between the network entity and the UE from a first BWP of the set of multiple BWPs to a second BWP of the set of multiple BWPs based on the network entity entering the DTX cycle or the DRX cycle in accordance with the second control signaling.

Some examples of the method, apparatuses, and non-transitory computer-readable medium described herein may further include operations, features, means, or instructions for receiving, with the first control signaling, an indication of a default BWP, where the second BWP may be the default BWP.

Some examples of the method, apparatuses, and non-transitory computer-readable medium described herein may further include operations, features, means, or instructions for receiving, with the first control signaling or the second control signaling, an indication that the second BWP may be associated with the at least one of the DTX cycle or the DRX cycle.

Some examples of the method, apparatuses, and non-transitory computer-readable medium described herein may further include operations, features, means, or instructions for receiving third control signaling indicating a triggering condition for switching the active BWP, where switching the active BWP may be based on the DTX cycle or the DRX cycle satisfying the triggering condition.

In some examples of the method, apparatuses, and non-transitory computer-readable medium described herein, the triggering condition includes at least one of a first duration between active periods of the DTX cycle or a second duration between active periods of the DRX cycle.

Some examples of the method, apparatuses, and non-transitory computer-readable medium described herein may further include operations, features, means, or instructions for switching the active BWP from the second BWP to the first BWP based on the network entity entering an active period of the DTX cycle or the DRX cycle in accordance with the second control signaling, where switching the active BWP from the first BWP to the second BWP based on the network entity entering the DTX cycle or the DRX cycle includes switching the active BWP from the first BWP to the second BWP based on the network entity entering an inactive period of the DTX cycle or the DRX cycle in accordance with the second control signaling.

Some examples of the method, apparatuses, and non-transitory computer-readable medium described herein may further include operations, features, means, or instructions for receiving, with the first control signaling or the second control signaling, an indication that the second BWP may be associated with the DTX cycle and that a third BWP of the set of multiple BWPs may be associated with the DRX cycle, monitoring for downlink signaling from the network entity in the second BWP during the DTX cycle, and transmitting uplink signaling to the network entity in the third BWP during the DRX cycle.

In some examples of the method, apparatuses, and non-transitory computer-readable medium described herein, switching the active BWP may include operations, features, means, or instructions for switching the active BWP based on an inactivity timer satisfying a threshold.

Some examples of the method, apparatuses, and non-transitory computer-readable medium described herein may further include operations, features, means, or instructions for running the inactivity timer during an active period of the DTX cycle or the DRX cycle and pausing the inactivity timer during an inactive period of the DTX cycle or the DRX cycle.

In some examples of the method, apparatuses, and non-transitory computer-readable medium described herein, pausing the inactivity timer may include operations, features, means, or instructions for pausing the inactivity timer during the inactive period based on the inactive period satisfying a threshold duration.

Some examples of the method, apparatuses, and non-transitory computer-readable medium described herein may further include operations, features, means, or instructions for starting the inactivity timer a period of time after the network entity enters the DTX cycle or the DRX cycle.

Some examples of the method, apparatuses, and non-transitory computer-readable medium described herein may further include operations, features, means, or instructions for receiving third control signaling indicating the period of time.

A method for wireless communications at a network entity is described. The method may include transmitting, to a UE, first control signaling indicating a set of multiple BWPs for the UE, transmitting, to the UE, second control signaling indicating at least one of a DTX cycle for the network entity or a DRX cycle for the network entity, and switching an active BWP for communication between the network entity and the UE from a first BWP of the set of multiple BWPs to a second BWP of the set of multiple BWPs based on the network entity entering the DTX cycle or the DRX cycle in accordance with the second control signaling.

An apparatus for wireless communications at a network entity is described. The apparatus may include a processor, memory coupled with the processor, and instructions stored in the memory. The instructions may be executable by the processor to cause the apparatus to transmit, to a UE, first control signaling indicating a set of multiple BWPs for the UE, transmit, to the UE, second control signaling indicating at least one of a DTX cycle for the network entity or a DRX cycle for the network entity, and switch an active BWP for communication between the network entity and the UE from a first BWP of the set of multiple BWPs to a second BWP of the set of multiple BWPs based on the network entity entering the DTX cycle or the DRX cycle in accordance with the second control signaling.

Another apparatus for wireless communications at a network entity is described. The apparatus may include means for transmitting, to a UE, first control signaling indicating a set of multiple BWPs for the UE, means for transmitting, to the UE, second control signaling indicating at least one of a DTX cycle for the network entity or a DRX cycle for the network entity, and means for switching an active BWP for communication between the network entity and the UE from a first BWP of the set of multiple BWPs to a second BWP of the set of multiple BWPs based on the network entity entering the DTX cycle or the DRX cycle in accordance with the second control signaling.

A non-transitory computer-readable medium storing code for wireless communications at a network entity is described. The code may include instructions executable by a processor to transmit, to a UE, first control signaling indicating a set of multiple BWPs for the UE, transmit, to the UE, second control signaling indicating at least one of a DTX cycle for the network entity or a DRX cycle for the network entity, and switch an active BWP for communication between the network entity and the UE from a first BWP of the set of multiple BWPs to a second BWP of the set of multiple BWPs based on the network entity entering the DTX cycle or the DRX cycle in accordance with the second control signaling.

Some examples of the method, apparatuses, and non-transitory computer-readable medium described herein may further include operations, features, means, or instructions for transmitting, with the first control signaling, an indication of a default BWP, where the second BWP may be the default BWP.

Some examples of the method, apparatuses, and non-transitory computer-readable medium described herein may further include operations, features, means, or instructions for transmitting, with the first control signaling or the second control signaling, an indication that the second BWP may be associated with the at least one of the DTX cycle or the DRX cycle.

Some examples of the method, apparatuses, and non-transitory computer-readable medium described herein may further include operations, features, means, or instructions for transmitting, to the UE, third control signaling indicating a triggering condition for switching the active BWP, where switching the active BWP may be based on the DTX cycle or the DRX cycle satisfying the triggering condition.

In some examples of the method, apparatuses, and non-transitory computer-readable medium described herein, the triggering condition includes at least one of a first duration between active periods of the DTX cycle or a second duration between active periods of the DRX cycle.

Some examples of the method, apparatuses, and non-transitory computer-readable medium described herein may further include operations, features, means, or instructions for switching the active BWP from the second BWP to the first BWP based on the network entity entering an active period of the DTX cycle or the DRX cycle in accordance with the second control signaling, where switching the active BWP from the first BWP to the second BWP based on the network entity entering the DTX cycle or the DRX cycle includes switching the active BWP from the first BWP to the second BWP based on the network entity entering an inactive period of the DTX cycle or the DRX cycle in accordance with the second control signaling.

Some examples of the method, apparatuses, and non-transitory computer-readable medium described herein may further include operations, features, means, or instructions for transmitting, with the first control signaling or the second control signaling, an indication that the second BWP may be associated with the DTX cycle and that a third BWP of the set of multiple BWPs may be associated with the DRX cycle, transmitting downlink signaling to the UE in the second BWP during the DTX cycle, and receiving uplink signaling from the UE in the third BWP during the DRX cycle.

Some examples of the method, apparatuses, and non-transitory computer-readable medium described herein may further include operations, features, means, or instructions for transmitting, to the UE, third control signaling indicating a period of time after the network entity enters the DTX cycle or the DRX cycle for initiation of an inactivity timer at the UE.

### BRIEF DESCRIPTION OF THE DRAWINGS

FIG. 1 shows an example of a wireless communications system that supports techniques for bandwidth part (BWP) interaction with cell discontinuous reception (DRX) and cell discontinuous transmission (DTX) in accordance with one or more aspects of the present disclosure.

FIG. 2 shows an example of a wireless communications system that supports techniques for BWP interaction with cell DRX and cell DTX in accordance with one or more aspects of the present disclosure.

FIG. 3 shows an example of a BWP switching configuration diagram that supports techniques for BWP interaction with cell DRX and cell DTX in accordance with one or more aspects of the present disclosure.

FIG. 4 shows an example of a BWP switching configuration diagram that supports techniques for BWP interaction with cell DRX and cell DTX in accordance with one or more aspects of the present disclosure.

FIG. 5 shows an example of a process flow that supports techniques for BWP interaction with cell DRX and cell DTX in accordance with one or more aspects of the present disclosure.

FIGS. 6 and 7 show block diagrams of devices that support techniques for BWP interaction with cell DRX and cell DTX in accordance with one or more aspects of the present disclosure.

FIG. 8 shows a block diagram of a communications manager that supports techniques for BWP interaction with cell DRX and cell DTX in accordance with one or more aspects of the present disclosure.

FIG. 9 shows a diagram of a system including a device that supports techniques for BWP interaction with cell DRX and cell DTX in accordance with one or more aspects of the present disclosure.

FIGS. 10 and 11 show block diagrams of devices that support techniques for BWP interaction with cell DRX and cell DTX in accordance with one or more aspects of the present disclosure.

FIG. 12 shows a block diagram of a communications manager that supports techniques for BWP interaction with cell DRX and cell DTX in accordance with one or more aspects of the present disclosure.

FIG. 13 shows a diagram of a system including a device that supports techniques for BWP interaction with cell DRX and cell DTX in accordance with one or more aspects of the present disclosure.

FIGS. 14 and 15 show flowcharts illustrating methods that support techniques for BWP interaction with cell DRX and cell DTX in accordance with one or more aspects of the present disclosure.

### DETAILED DESCRIPTION

In some wireless communications systems, a network entity (e.g., a cell) may enter an inactive mode or a sleep mode, for example, to save power. For example, a network entity may enter a discontinuous reception (DRX) and/or a discontinuous transmission (DTX) cycle. In a DRX cycle, the network entity cycles between an active or “on” duration during which the network entity monitors for uplink signaling and an inactive or “off” duration during which the network entity does not monitor for uplink signaling. In a DTX cycle, the network entity cycles between an inactive or “off” duration during which the network entity does not transmit downlink signaling and active or “on” duration during which the network entity transmits downlink signaling. The network entity may indicate to a user equipment (UE) via control signaling that the network entity will enter a DRX and/or a DTX cycle so that the UE may transmit uplink signaling to the network entity during the active periods of the DRX cycle and/or monitor for downlink signaling from the network entity during the active periods of the DTX cycle. The UE may be configured with multiple bandwidth parts (BWPs). Some BWPs may be associated with lower energy consumption at the UE and/or the network entity, for example, based on a narrower bandwidth. For example, a UE may be configured to switch from one BWP to a default BWP based on the expiration of an inactivity timer. Currently, UEs are not configured to switch BWPs based on the network entity operating in a DTX or DRX mode, and inactivity timers do not account for the network operating in a DTX or DRX mode, which may result in use of a BWP associated with higher energy consumption.

A UE configured with multiple BWPs may switch from a first BWP to a second BWP based on the network entity entering a DTX or DRX cycle. In some aspects, the UE may be configured to switch to a default BWP (e.g., that is associated with lower energy consumption) based on the network entity entering a DTX or DRX cycle. In some aspects, one of the multiple BPWs may be explicitly associated with cell DTX and/or DRX, and the UE may switch to that BWP when the network entity enters a DTX or DRX cycle. In some aspects, an uplink BWP may be associated with cell DRX and a downlink BWP may be associated with cell DTX. In some aspects, to avoid frequent BWP switching, the UE may switch the BWP when the DTX or DRX cycle duration (or the inactive periods of the DTX cycle or the DRX cycle) exceeds a configured threshold. The inactivity timer may be adjusted to account for cell DTX and/or cell DRX. For example, the inactivity timer may be paused during the inactive duration (e.g., as the UE is not expected to receive or transmit during the inactive periods). In some cases, an offset may be added to the inactivity timer as the UE is not expected to receive or transmit during the inactive periods.

Aspects of the disclosure are initially described in the context of wireless communications systems. Aspects of the disclosure are further illustrated by and described with reference to BWP switching configuration diagrams, process flows, apparatus diagrams, system diagrams, and flowcharts that relate to techniques for BWP interaction with cell DRX and cell DTX.

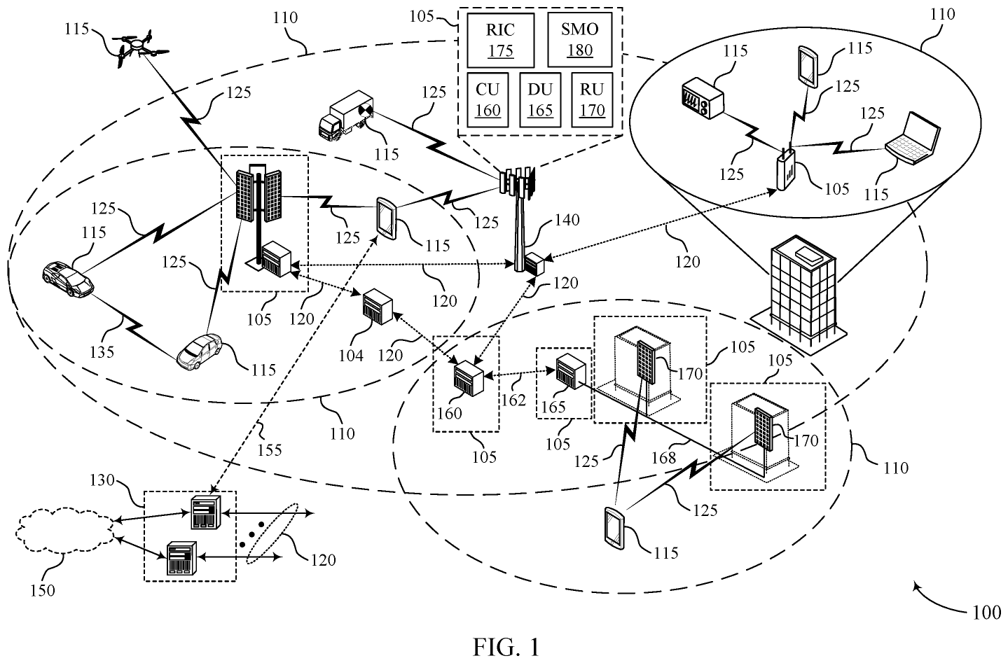

FIG. 1 shows an example of a wireless communications system 100 that supports techniques for BWP interaction with cell DRX and cell DTX in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for BWP interaction with cell DRX and cell DTX as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some examples of the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell, for example, covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). For example, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with an orientation (e.g., with respect to the antenna array of the transmitting device or receiving device, or with respect to some other orientation).

A network entity 105 may operate in different modes to save power and maintain network operation. In some aspects, a network entity 105 may switch power modes according to the network input and the current traffic conditions. For example, a network entity 105 may enter an inactive mode or a sleep mode to save power. For example, a network entity 105 may enter a DRX and/or a DTX cycle. In a DRX cycle, the network entity 105 cycles between an active or “on” duration during which the network entity 105 monitors for uplink signaling and an inactive or “off” duration during which the network entity 105 does not monitor for uplink signaling. In a DTX cycle, the network entity 105 cycles between an inactive or “off” duration during which the network entity 105 does not transmit downlink signaling and active or “on” duration during which the network entity 105 transmits downlink signaling. In a cell DTX/DRX mode, the network entity may align the service periods for the served UEs 115 during the active period (e.g., of the DTX cycle and/or the DRX cycle) instead of spreading the services for the served UEs across all times. Cell DTX/DRX is accordingly similar to UE DTX/DRX, but from the network perspective. The network entity 105 may indicate to a UE 115 via control signaling (e.g., via RRC, a MAC control element (MAC-CE), or downlink control information (DCI)) that the network entity 105 will enter a DRX and/or a DTX cycle so that the UE 115 may transmit uplink signaling to the network entity 105 during the active periods of the DRX cycle and/or monitor for downlink signaling from the network entity 105 during the active periods of the DTX cycle. Thus, sharing cell DTX cycle information and/or cell DRX cycle information may enable the UE 115 to utilize the cell DRX cycle and/or the cell DTX cycle to save energy.

The UE 115 may be configured by the network entity 105 with multiple BWPs. For example, for the UE 115, up to four BWPs may be configured for downlink and up to four BWPs may be configured for uplink. A BWP may be contiguous in the frequency domain (e.g., include a contiguous set of frequency resources). Some BWPs may be associated with lower energy consumption at the UE 115 and/or the network entity 105, for example, based on a narrower bandwidth. For example, it may take less energy to monitor a BWP with a narrower bandwidth. A UE 115 may switch the active BWP (e.g., for downlink, uplink, or both) when indicated by the network to switch the active BWP in control signaling. For example, a DCI may include a BWP indicator. As another example, RRC signaling or a MAC entity may indicate to the UE 115 to switch the active BWP. As another example, a UE 115 may be configured to switch from one downlink BWP to a default downlink BWP based on the expiration of an inactivity timer at the UE. The inactivity timer may be configured in RRC (e.g., in the RRC field ServingCellConfig.bwp-InactivityTimer). In TDD communications, the downlink and uplink BWPs may switch simultaneously. In FDD communications, the downlink and uplink BWPs may switch independently.

The inactivity timer and the default BWP may be used to switch to the default BWP when there is no activity (e.g., no communications between the UE 115 and the network entity 105). During the inactive period of a cell DRX cycle and/or the inactive period of a cell DTX cycle, there may be no activity (e.g., except for initial access communications or other agreed upon signaling). If a UE 115 is not configured to switch the active BWP based on the network entity 105 entering a DTX or DRX mode, the UE may use a BWP associated with higher energy consumption while the cell operates in a DRX or DTX cycle. Additionally, or alternatively, absence of accounting for the inactive periods of a cell DRX cycle and/or a the inactive period of a cell DTX cycle may result in frequency BWP switching if based on an inactivity timer.

A UE 115 configured with multiple BWPs may switch from a first BWP to a second BWP based on the network entity 105 entering a DTX or DRX cycle. In some aspects, the UE 115 may be configured to switch to a default BWP (e.g., that is associated with lower energy consumption) based on the network entity entering a DTX or DRX cycle. In some aspects, one of the multiple BPWs may be explicitly associated with cell DTX and/or cell DRX, and the UE 115 may switch to that BWP when the network entity 105 enters a DTX or DRX cycle. In some aspects, an uplink BWP may be associated with cell DRX and a downlink BWP may be associated with cell DTX. In some aspects, to avoid frequent BWP switching, the UE 115 may switch the BWP when the DTX or DRX cycle duration (or the inactive periods of the DTX cycle or DRX cycle) exceeds a configured threshold. The inactivity timer may be adjusted to account for cell DTX and/or cell DRX. For example, the inactivity timer may be paused during the inactive duration (e.g., as the UE 115 is not expected to receive or transmit during the inactive periods). In some cases, an offset may be added to the inactivity timer as the UE 115 is not expected to receive or transmit during the inactive periods.

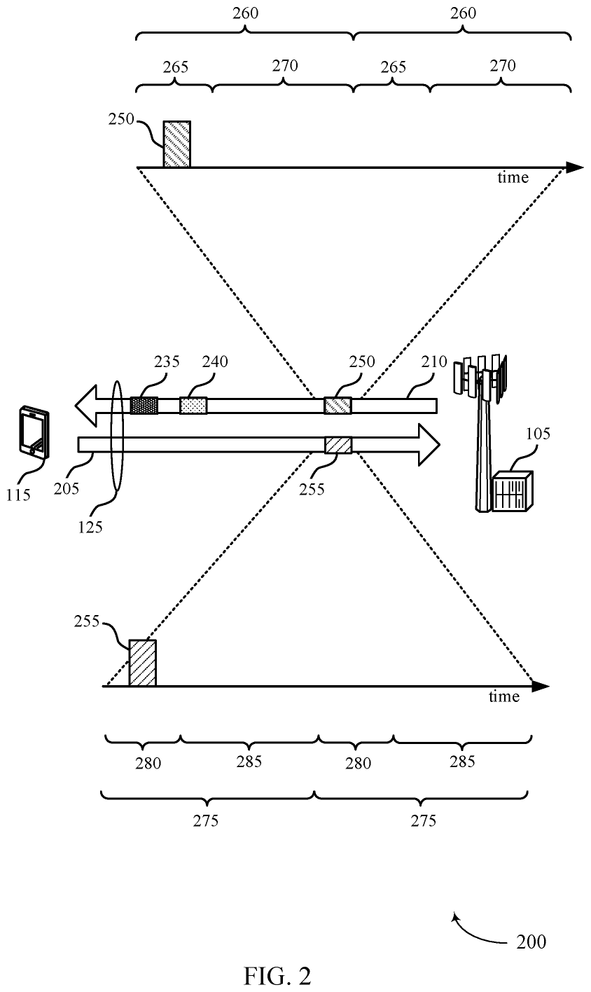

FIG. 2 shows an example of a wireless communications system 200 that supports techniques for BWP interaction with cell DRX and cell DTX in accordance with one or more aspects of the present disclosure. The wireless communications system 200 may implement aspects of wireless communications system 100. The wireless communications system 200 may include a network entity 105 and a UE 115. The network entity 105 and UE 115 may be examples of corresponding network entities 105 and UEs 115, respectively, as described herein with reference to FIG. 1.

The UE 115 may communicate with the network entity 105 using a communication link 125, which may be an example of a communication link 125 as described herein with reference to FIG. 1. The communication link 125 may be an example of an NR or LTE link between the UE 115 and the network entity 105. The communication link 125 may include a bi-directional link that enables both uplink and downlink communications. For example, the UE 115 may transmit uplink signals 205 (e.g., uplink transmissions), such as uplink control signals or uplink data signals, to the network entity 105 using the communication link 125, and the network entity 105 may transmit downlink signals 210 (e.g., downlink transmissions), such as downlink control signals or downlink data signals, to the UE 115 using the communication link 125.

As described herein, the UE 115 may be configured with multiple BPWs. For example, the network entity 105 may transmit control signaling 235 (e.g., RRC) that indicates the multiple BWPs for the UE 115. The control signaling 235 may indicate an active BWP for the UE (e.g., for TDD the same BWP for downlink and uplink or for FDD an active uplink BWP and an active downlink BWP). The UE 115 and the network entity 105 may communicate using the active BWP(s).

As described herein, the network entity 105 may enter a DTX cycle 260 or a DRX cycle 275. In a DTX cycle 260, the network entity 105 cycles between an active duration 265 during which the network entity 105 transmits downlink signals 210 and an inactive duration 270 during which the network entity 105 does not transmit downlink signals. In a DRX cycle 275, the network entity 105 cycles between an active duration 280 during which the network entity 105 monitors for uplink signals 205 and an inactive duration 285 during which the network entity 105 does not monitor for uplink signals. The network entity 105 may transmit control signaling 240 (e.g., RRC) to the UE 115 indicating that the network entity 105 will enter one or both of the DTX cycle 260 or the DRX cycle 275. The control signaling 240 may indicate one or more parameters of the DTX cycle 260 or the DRX cycle 275. For example, the control signaling 240 may indicate the lengths and timings of the active duration 265 and the inactive duration 270 of the DTX cycle 260 and/or the lengths and timings of the active duration 280 and the inactive duration 285 of the DRX cycle 275.

The UE 115 (and the network entity 105) may switch the active BWP based on the network entity 105 entering the DTX cycle 260 and/or the DRX cycle 275. In some examples, a default BWP may be configured (e.g., indicated in the control signaling 235), and the UE 115 and the network entity 105 may switch the active BWP to the default BWP when the network entity 105 starts the DTX cycle 260 or the DRX cycle 275.

In some examples, a BWP may be configured for or dedicated for the DTX cycle 260 and/or the DRX cycle 275. For example, the control signaling 235 or the control signaling 240 may indicate that one of the configured BWPs is associated with cell DTX or cell DRX. When the network entity 105 starts the DTX cycle 260 or the DRX cycle 275, the UE 115 (and the network entity 105) may switch the active BWP to the BWP that is indicated as being associated with cell DTX or cell DRX. In some examples, the UE 115 (and the network entity 105) may switch to the default BWP or the BWP that is indicated as associated with cell DTX or cell DRX if the DTX cycle 260 or the DRX cycle 275 has one or more configured properties (which may be configured in RRC signaling). For example, if the inactive duration 270 of the DTX cycle 260 or the inactive duration 285 of the DRX cycle 275 exceeds a configured threshold length, the UE 115 may switch the active BWP to the default BWP or the BWP that is indicated as associated with cell DTX or cell DRX.

In some aspects, the UE 115 may use a first BWP during the active duration 265 of the DTX cycle 260 and may use a second BWP during the inactive duration 270 of the DTX cycle 260 (e.g., the UE 115 may switch the active BWP between the first BWP and the second BWP as the network entity 105 switches between the active duration 265 of the DTX cycle 260 and the inactive duration 270 of the DTX cycle 260). In some aspects, the UE 115 may use a first BWP during the active duration 280 of the DRX cycle 275 and may use a second BWP during the inactive duration 285 of the DRX cycle 275 (e.g., the UE 115 may switch the active BWP between the first BWP and the second BWP as the network entity 105 switches between the active duration 280 of the DRX cycle 275 and the inactive duration 285 of the DRX cycle 275). In some aspects, in TDD, if the DTX cycle 260 and the DRX cycle 275 are aligned, the UE 115 may use a first BWP during the active duration 265 of the DTX cycle 260 and the active duration 280 of the DRX cycle 275 and may use a second BWP during the inactive duration 270 of the DTX cycle 260 and the inactive duration 285 of the DRX cycle 275. In some aspects, in TDD, if the DTX cycle 260 and the DRX cycle 275 are not aligned, a different BWP may be defined for each mode of transmission and reception in TDD.

Expiration of an inactivity timer at the UE 115 may trigger the UE 115 to switch the active downlink BWP to the default BWP. In some aspects, the inactivity timer may be adjusted based on the network operating in the DTX cycle 260 or the DRX cycle 275. For example, the UE 115 may pause the inactivity timer during the inactive duration 270 of the DTX cycle 260 as the UE 115 does not expect to receive downlink signals 210 during the inactive duration 270 of the DTX cycle 260 and the UE 115 may run the inactivity timer during the active duration 265 of the DTX cycle 260 (e.g., from reception of a downlink signal 210). In some aspects, the UE 115 may pause the inactivity timer during the inactive duration 270 of the DTX cycle 260 if the inactive duration 270 of the DTX cycle 260 satisfies a triggering condition (e.g., has a longer or shorter length than a configured threshold). In some aspects, an offset may be added to the inactivity timer which may be applied when the cell enters the DTX cycle 260. The offset may be RRC configured. In some examples, the offset may be a function of the DTX cycle 260 (e.g., may be based on the length of the DTX cycle 260).

After switching the active BWP for downlink (e.g., the active downlink BWP in FDD or the active BWP in TDD), the UE 115 may receive a downlink communication 250 from the network entity 105 during the active duration 265 of the DTX cycle 260 via the active BWP for downlink. After switching the active BWP for uplink (e.g., the active uplink BWP in FDD or the active BWP in TDD), the UE 115 may transmit an uplink communication 255 to the network entity 105 during the active duration 280 of the DRX cycle 275 via the active BWP for uplink.

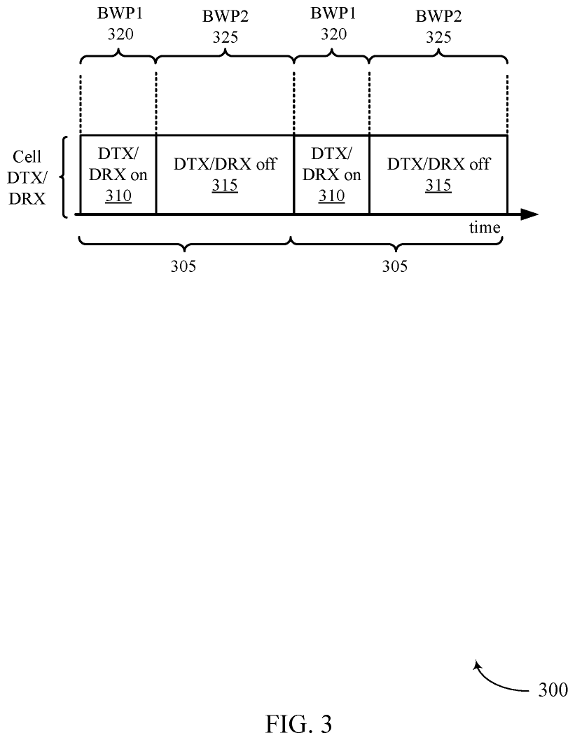

FIG. 3 shows an example of a BWP switching configuration diagram 300 that supports techniques for BWP interaction with cell DRX and cell DTX in accordance with one or more aspects of the present disclosure. The BWP switching configuration diagram 300 may implement or may be implemented by aspects of the wireless communications system 100 or the wireless communications system 200.

As described herein, a network entity 105 may operate in accordance with a DRX or DTX cycle 305, which may include an off duration 315 during which the network entity 105 does not monitor for uplink signaling (DRX off duration) or transmit downlink signaling (DTX off duration) and an on duration 310 during which the network entity 105 monitors for uplink signaling (DRX on duration) or transmits downlink signaling (DTX on duration). In some aspects, a UE 115 and a network entity 105, as described with reference to FIGS. 1 and 2, may switch between a first BWP 320 used during the on duration 310 and a second BWP 325 used during the off duration 315. For example, the second BWP 325 may have a narrower bandwidth, as the UE 115 and the network entity 105 do not expect to transmit/receive during the off duration, and the second BWP 325 may accordingly be associated with lower energy use at the network entity 105 and/or the UE 115.

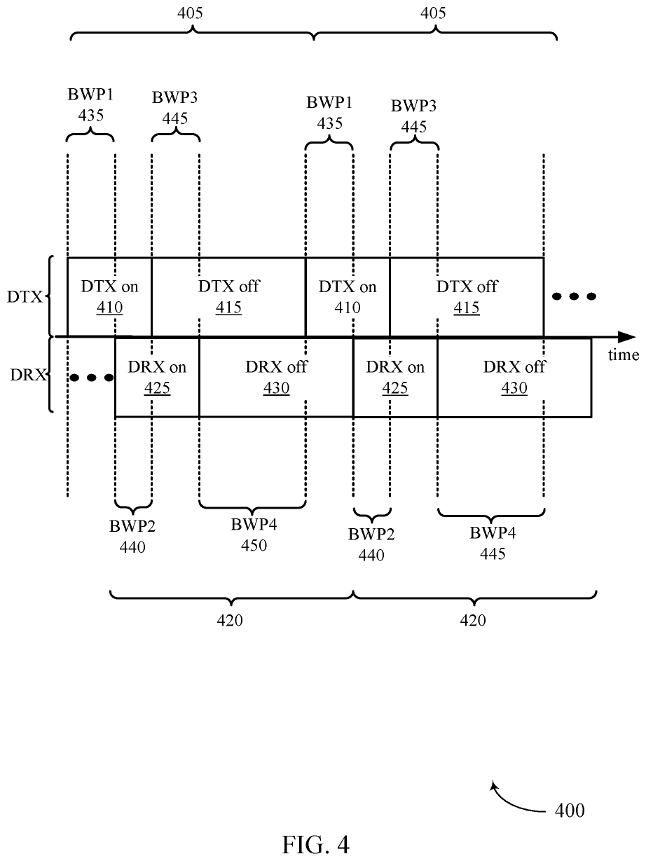

FIG. 4 shows an example of a BWP switching configuration diagram 400 that supports techniques for BWP interaction with cell DRX and cell DTX in accordance with one or more aspects of the present disclosure. The BWP switching configuration diagram 400 may implement or may be implemented by aspects of the wireless communications system 100 or the wireless communications system 200.

As described herein, a network entity 105 may operate in accordance with a DTX cycle 405 and a DRX cycle 420. In the DTX cycle 405, a network entity 105, as described with reference to FIGS. 1 and 2, cycles between an on duration 410 during which the network entity 105 transmits downlink signals and an off duration 415 during which the network entity 105 does not transmit downlink signals. In the DRX cycle 420, the network entity 105 cycles between an on duration 425 during which the network entity 105 monitors for uplink signals and an off duration 430 during which the network entity 105 does not monitor for uplink signals. In TDD, the DTX cycle 405 may not be aligned in time with the DRX cycle 420. For example, the on duration 410 of the DTX cycle 405 may not completely overlap with the on duration 425 of the DRX cycle 420, and the off duration 415 of the DTX cycle 405 may not completely overlap with the off duration 430 of the DRX cycle 420.

In such examples where the DTX cycle 405 may not be aligned with the DRX cycle 420, a different BWP may be configured for each mode of transmission and reception. For example, a UE 115, as described with reference to FIGS. 1 and 2, and the network entity 105 may use a first BWP 435 during a first period where the network entity 105 is in the on duration 410 of the DTX cycle and the off duration 430 of the DRX cycle 420. The UE 115 and the network entity 105 may use a second BWP 440 during a second period where the network entity 105 is in the on duration 410 of the DTX cycle 405 and the on duration 425 of the DRX cycle 420. The UE 115 and the network entity 105 may use a third BWP 445 during a third period where the network entity 105 is in the off duration 415 of the DTX cycle 405 and the on duration 425 of the DRX cycle 420. The UE 115 and the network entity 105 may use a fourth BWP 450 during a fourth period where the network entity 105 is in the off duration 415 of the DTX cycle 405 and the off duration 430 of the DRX cycle 420.

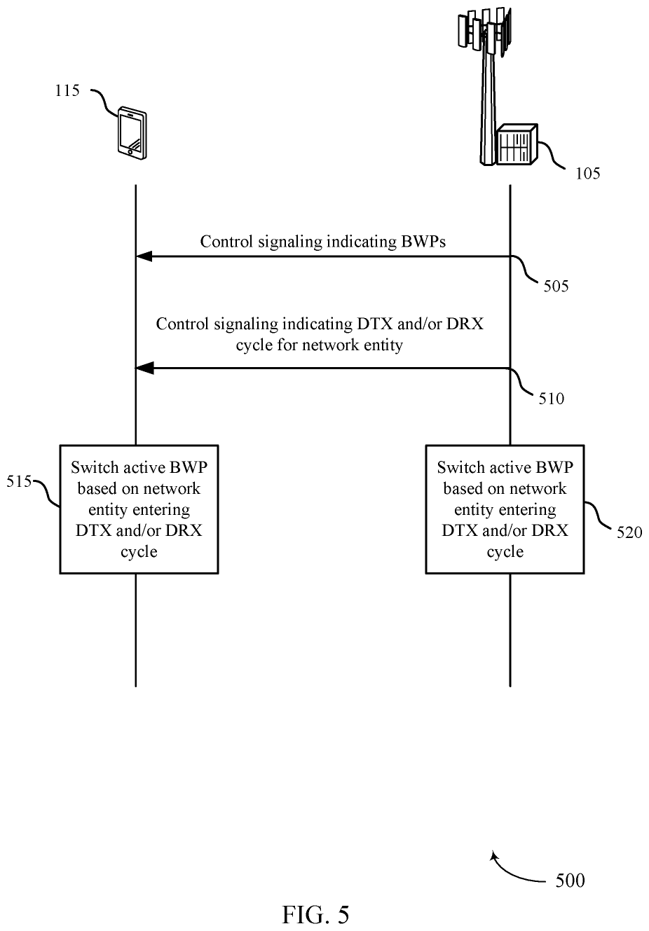

FIG. 5 shows an example of a process flow 500 that supports techniques for BWP interaction with cell DRX and cell DTX in accordance with one or more aspects of the present disclosure. The process flow 500 may include a network entity 105 and a UE 115. The network entity 105 may be an example of a network entity 105 described herein. The UE 115 may be an example of a UE 115 described herein. In the following description of the process flow 500, the operations between the network entity 105 and the UE 115 may be transmitted in a different order than the example order shown, or the operations performed by the network entity 105 and the UE 115 may be performed in different orders or at different times. Some operations may also be omitted from the process flow 500, and other operations may be added to the process flow 500.

At 505 the network entity 105 may transmit, to the UE 115, first control signaling (e.g., RRC signaling) indicating a set of multiple BWPs for the UE 115.

At 510, the network entity 105 may transmit, to the UE 115, second control signaling (e.g., RRC, MAC-CE, or DCI) indicating at least one of a DTX cycle for the network entity 105 or a DRX cycle for the network entity 105.

At 515, the UE 115 may switch an active BWP for communication between the network entity 105 and the UE 115 from a first BWP of the set of multiple BWPs to a second BWP of the set of multiple BWPs based on the network entity 105 entering the DTX cycle or the DRX cycle in accordance with the second control signaling. At 520, the network entity 105 may also switch the active BWP for communication between the network entity 105 and the UE 115 from the first BWP of the set of multiple BWPs to the second BWP of the set of multiple BWPs based on the network entity 105 entering the DTX cycle or the DRX cycle in accordance with the second control signaling.

In some examples, the first control signaling may include an indication of a default BWP, and the second BWP is the default BWP.

In some examples, the first control signaling or the second control signaling may include an indication that the second BWP is associated with the at least one of the DTX cycle or the DRX cycle.

In some examples, the network entity 105 may transmit, to the UE 115, third control signaling (e.g., RRC) indicating a triggering condition for switching the active BWP, where switching the active BWP is based on the DTX cycle or the DRX cycle satisfying the triggering condition. In some examples, the triggering condition is at least one of a first duration between active periods of the DTX cycle or a second duration between active periods of the DRX cycle.

In some examples, the UE 115 and the network entity 105 may switch the active BWP from the second BWP to the first BWP based on the network entity 105 entering an active period of the DTX cycle or the DRX cycle in accordance with the second control signaling, where switching the active BWP from the first BWP to the second BWP based on the network entity 105 entering the DTX cycle or the DRX cycle includes switching the active BWP from the first BWP to the second BWP based on the network entity 105 entering an inactive period of the DTX cycle or the DRX cycle in accordance with the second control signaling.

In some examples, the first control signaling or the second control signaling may include an indication that the second BWP is associated with the DTX cycle and that a third BWP of the set of multiple BWPs is associated with the DRX cycle. The UE 115 may monitor for downlink signaling from the network entity 105 in the second BWP during the DTX cycle and the network entity 105 may transmit downlink signaling to the UE 115 in the second BWP during the DTX cycle. The UE 115 may transmit uplink signaling to the network entity 105 in the third BWP during the DRX cycle and the network entity 105 may receive uplink signaling from the UE in the third BWP during the DRX cycle.

In some examples, switching the active BWP further includes switching the active BWP based on an inactivity timer at the UE 115 satisfying a threshold. In some examples, the UE 115 may run the inactivity timer during an active period of the DTX cycle or the DRX cycle and pause the inactivity timer during an inactive period of the DTX cycle or the DRX cycle. In some examples, pausing the inactivity timer includes pausing the inactivity timer during the inactive period based on the inactive period satisfying a threshold duration. In some examples, the UE 115 may start the inactivity timer a period of time after (e.g., an offset after) the network entity 105 enters the DTX cycle or the DRX cycle. In some examples, the network entity 105 may transmit, to the UE 115, third control signaling indicating the period of time.

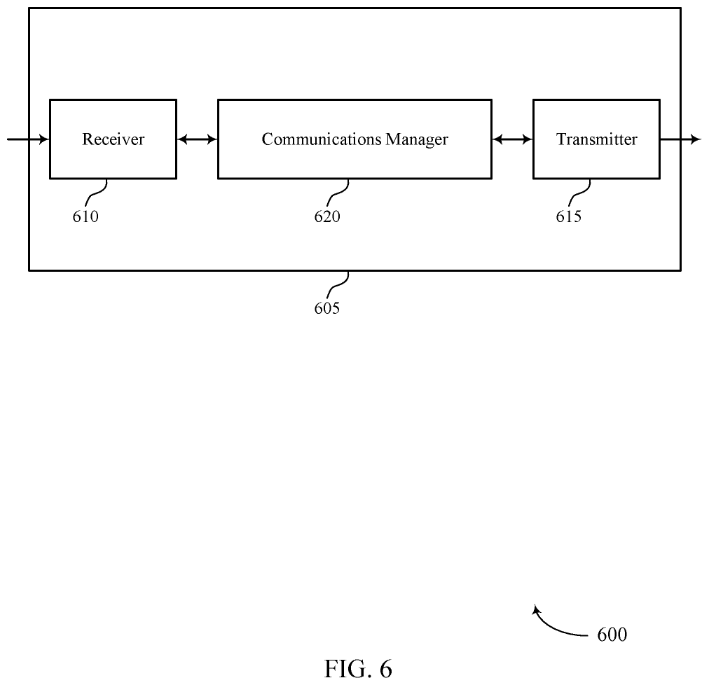

FIG. 6 shows a block diagram 600 of a device 605 that supports techniques for BWP interaction with cell DRX and cell DTX in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for BWP interaction with cell DRX and cell DTX). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for BWP interaction with cell DRX and cell DTX). In some examples, the transmitter 615 may be co-located with a receiver 610 in a transceiver component. The transmitter 615 may utilize a single antenna or a set of multiple antennas.

The communications manager 620, the receiver 610, the transmitter 615, or various combinations thereof or various components thereof may be examples of means for performing various aspects of techniques for BWP interaction with cell DRX and cell DTX as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at UE in accordance with examples as disclosed herein. For example, the communications manager 620 is capable of, configured to, or operable to support a means for receiving first control signaling indicating a set of multiple BWPs for the UE. The communications manager 620 is capable of, configured to, or operable to support a means for receiving, from a network entity, second control signaling indicating at least one of a DTX cycle for the network entity or a DRX cycle for the network entity. The communications manager 620 is capable of, configured to, or operable to support a means for switching an active BWP for communication between the network entity and the UE from a first BWP of the set of multiple BWPs to a second BWP of the set of multiple BWPs based on the network entity entering the DTX cycle or the DRX cycle in accordance with the second control signaling.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced power consumption and more efficient utilization of communication resources.

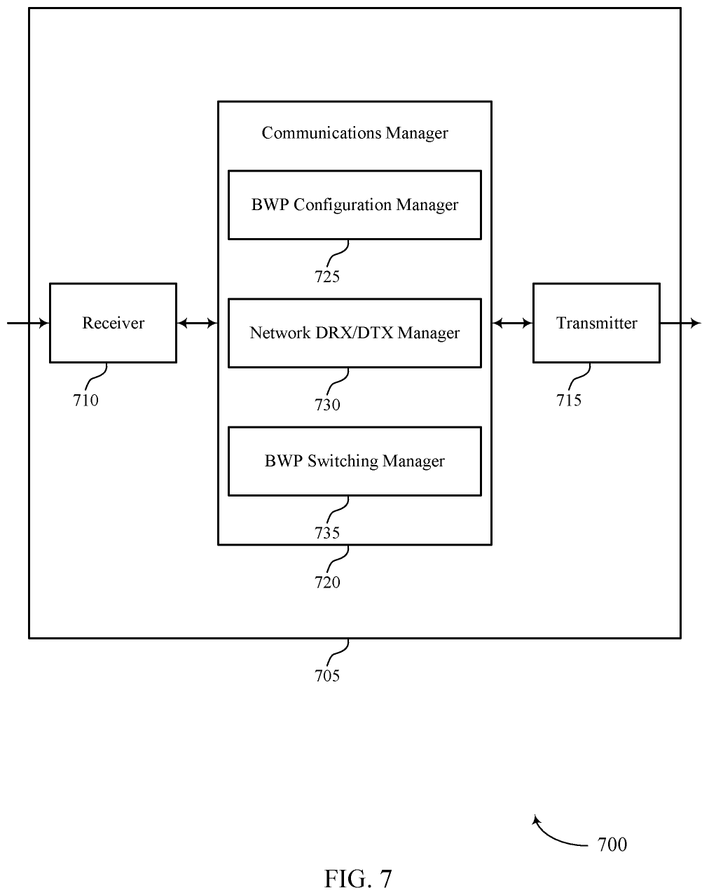

FIG. 7 shows a block diagram 700 of a device 705 that supports techniques for BWP interaction with cell DRX and cell DTX in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for BWP interaction with cell DRX and cell DTX). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for BWP interaction with cell DRX and cell DTX). In some examples, the transmitter 715 may be co-located with a receiver 710 in a transceiver component. The transmitter 715 may utilize a single antenna or a set of multiple antennas.

The device 705, or various components thereof, may be an example of means for performing various aspects of techniques for BWP interaction with cell DRX and cell DTX as described herein. For example, the communications manager 720 may include a BWP configuration manager 725, a network DRX/DTX manager 730, a BWP switching manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at UE in accordance with examples as disclosed herein. The BWP configuration manager 725 is capable of, configured to, or operable to support a means for receiving first control signaling indicating a set of multiple BWPs for the UE. The network DRX/DTX manager 730 is capable of, configured to, or operable to support a means for receiving, from a network entity, second control signaling indicating at least one of a DTX cycle for the network entity or a DRX cycle for the network entity. The BWP switching manager 735 is capable of, configured to, or operable to support a means for switching an active BWP for communication between the network entity and the UE from a first BWP of the set of multiple BWPs to a second BWP of the set of multiple BWPs based on the network entity entering the DTX cycle or the DRX cycle in accordance with the second control signaling.

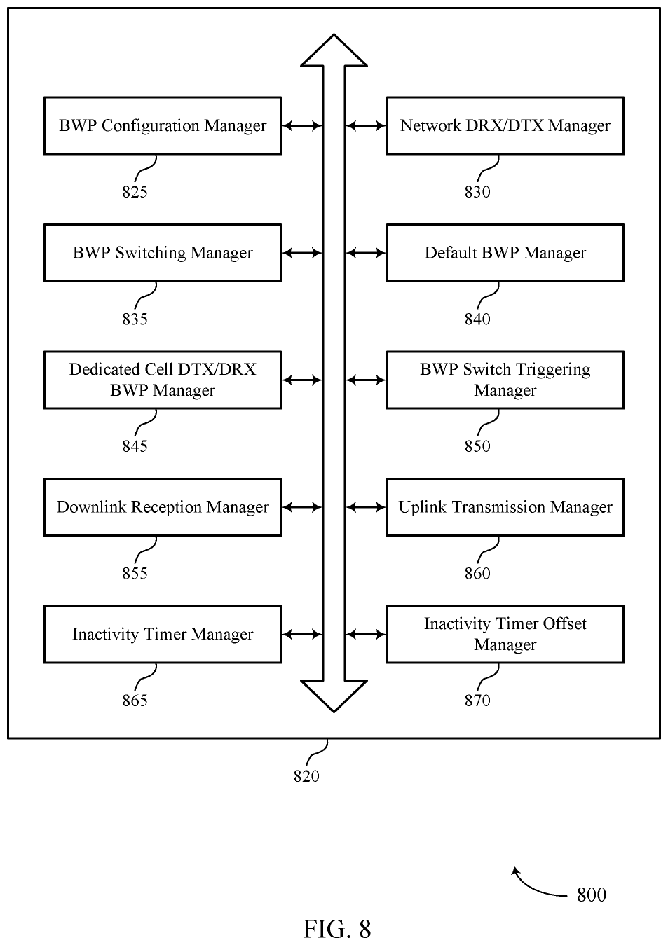

FIG. 8 shows a block diagram 800 of a communications manager 820 that supports techniques for BWP interaction with cell DRX and cell DTX in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for BWP interaction with cell DRX and cell DTX as described herein. For example, the communications manager 820 may include a BWP configuration manager 825, a network DRX/DTX manager 830, a BWP switching manager 835, a default BWP manager 840, a dedicated cell DTX/DRX BWP manager 845, a BWP switch triggering manager 850, a downlink reception manager 855, an uplink transmission manager 860, an inactivity timer manager 865, an inactivity timer offset manager 870, or any combination thereof. Each of these components may communicate, directly or indirectly, with one another (e.g., via one or more buses).

The communications manager 820 may support wireless communications at UE in accordance with examples as disclosed herein. The BWP configuration manager 825 is capable of, configured to, or operable to support a means for receiving first control signaling indicating a set of multiple BWPs for the UE. The network DRX/DTX manager 830 is capable of, configured to, or operable to support a means for receiving, from a network entity, second control signaling indicating at least one of a DTX cycle for the network entity or a DRX cycle for the network entity. The BWP switching manager 835 is capable of, configured to, or operable to support a means for switching an active BWP for communication between the network entity and the UE from a first BWP of the set of multiple BWPs to a second BWP of the set of multiple BWPs based on the network entity entering the DTX cycle or the DRX cycle in accordance with the second control signaling.

In some examples, the default BWP manager 840 is capable of, configured to, or operable to support a means for receiving, with the first control signaling, an indication of a default BWP, where the second BWP is the default BWP.

In some examples, the dedicated cell DTX/DRX BWP manager 845 is capable of, configured to, or operable to support a means for receiving, with the first control signaling or the second control signaling, an indication that the second BWP is associated with the at least one of the DTX cycle or the DRX cycle.

In some examples, the BWP switch triggering manager 850 is capable of, configured to, or operable to support a means for receiving third control signaling indicating a triggering condition for switching the active BWP, where switching the active BWP is based on the DTX cycle or the DRX cycle satisfying the triggering condition.

In some examples, the triggering condition includes at least one of a first duration between active periods of the DTX cycle or a second duration between active periods of the DRX cycle.

In some examples, the BWP switching manager 835 is capable of, configured to, or operable to support a means for switching the active BWP from the second BWP to the first BWP based on the network entity entering an active period of the DTX cycle or the DRX cycle in accordance with the second control signaling, where switching the active BWP from the first BWP to the second BWP based on the network entity entering the DTX cycle or the DRX cycle includes switching the active BWP from the first BWP to the second BWP based on the network entity entering an inactive period of the DTX cycle or the DRX cycle in accordance with the second control signaling.

In some examples, the BWP configuration manager 825 is capable of, configured to, or operable to support a means for receiving, with the first control signaling or the second control signaling, an indication that the second BWP is associated with the DTX cycle and that a third BWP of the set of multiple BWPs is associated with the DRX cycle. In some examples, the downlink reception manager 855 is capable of, configured to, or operable to support a means for monitoring for downlink signaling from the network entity in the second BWP during the DTX cycle. In some examples, the uplink transmission manager 860 is capable of, configured to, or operable to support a means for transmitting uplink signaling to the network entity in the third BWP during the DRX cycle.

In some examples, to support switching the active BWP, the inactivity timer manager 865 is capable of, configured to, or operable to support a means for switching the active BWP based on an inactivity timer satisfying a threshold.

In some examples, the inactivity timer manager 865 is capable of, configured to, or operable to support a means for running the inactivity timer during an active period of the DTX cycle or the DRX cycle. In some examples, the inactivity timer manager 865 is capable of, configured to, or operable to support a means for pausing the inactivity timer during an inactive period of the DTX cycle or the DRX cycle.

In some examples, to support pausing the inactivity timer, the inactivity timer manager 865 is capable of, configured to, or operable to support a means for pausing the inactivity timer during the inactive period based on the inactive period satisfying a threshold duration.

In some examples, the inactivity timer offset manager 870 is capable of, configured to, or operable to support a means for starting the inactivity timer a period of time after the network entity enters the DTX cycle or the DRX cycle.

In some examples, the inactivity timer offset manager 870 is capable of, configured to, or operable to support a means for receiving third control signaling indicating the period of time.

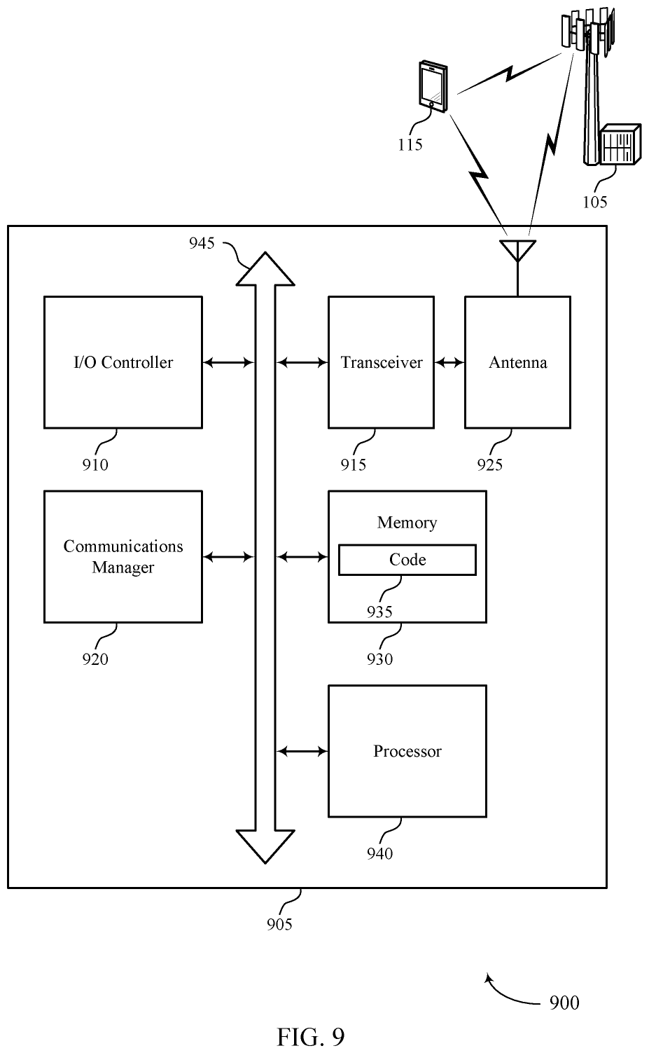

FIG. 9 shows a diagram of a system 900 including a device 905 that supports techniques for BWP interaction with cell DRX and cell DTX in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for BWP interaction with cell DRX and cell DTX). For example, the device 905 or a component of the device 905 may include a processor 940 and memory 930 coupled with or to the processor 940, the processor 940 and memory 930 configured to perform various functions described herein.

The communications manager 920 may support wireless communications at UE in accordance with examples as disclosed herein. For example, the communications manager 920 is capable of, configured to, or operable to support a means for receiving first control signaling indicating a set of multiple BWPs for the UE. The communications manager 920 is capable of, configured to, or operable to support a means for receiving, from a network entity, second control signaling indicating at least one of a DTX cycle for the network entity or a DRX cycle for the network entity. The communications manager 920 is capable of, configured to, or operable to support a means for switching an active BWP for communication between the network entity and the UE from a first BWP of the set of multiple BWPs to a second BWP of the set of multiple BWPs based on the network entity entering the DTX cycle or the DRX cycle in accordance with the second control signaling.

By including or configuring the communications manager 920 in accordance with examples as described herein, the device 905 may support techniques for reduced power consumption, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for BWP interaction with cell DRX and cell DTX as described herein, or the processor 940 and the memory 930 may be otherwise configured to perform or support such operations.

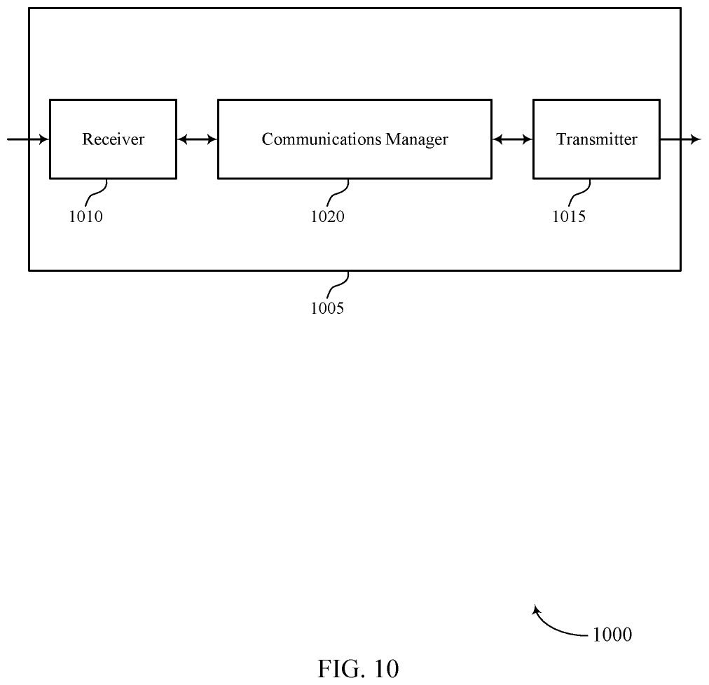

FIG. 10 shows a block diagram 1000 of a device 1005 that supports techniques for BWP interaction with cell DRX and cell DTX in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for BWP interaction with cell DRX and cell DTX as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 is capable of, configured to, or operable to support a means for transmitting, to a UE, first control signaling indicating a set of multiple BWPs for the UE. The communications manager 1020 is capable of, configured to, or operable to support a means for transmitting, to the UE, second control signaling indicating at least one of a DTX cycle for the network entity or a DRX cycle for the network entity. The communications manager 1020 is capable of, configured to, or operable to support a means for switching an active BWP for communication between the network entity and the UE from a first BWP of the set of multiple BWPs to a second BWP of the set of multiple BWPs based on the network entity entering the DTX cycle or the DRX cycle in accordance with the second control signaling.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced power consumption and more efficient utilization of communication resources.

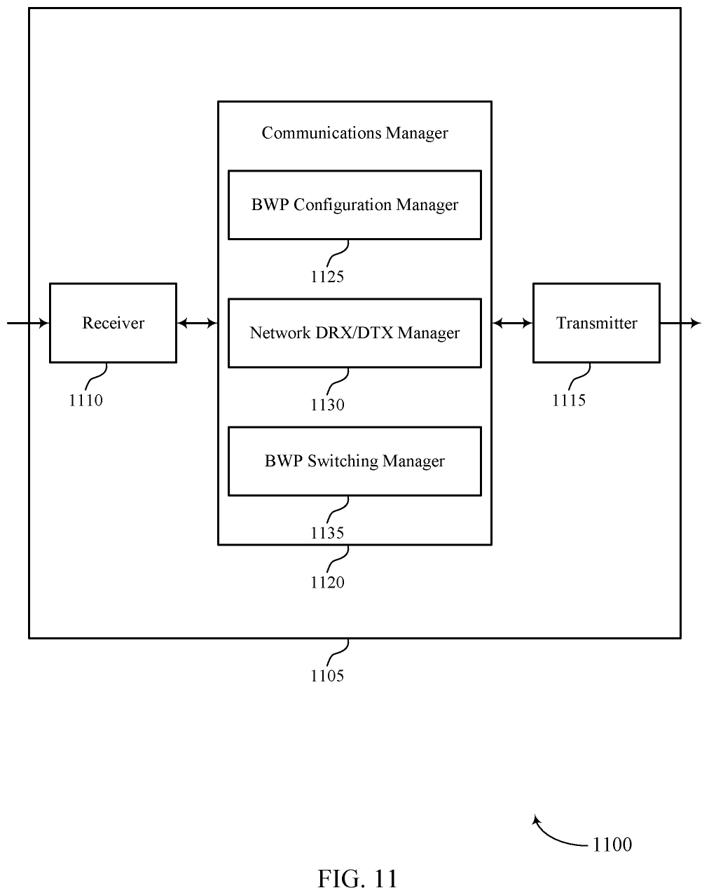

FIG. 11 shows a block diagram 1100 of a device 1105 that supports techniques for BWP interaction with cell DRX and cell DTX in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for BWP interaction with cell DRX and cell DTX as described herein. For example, the communications manager 1120 may include a BWP configuration manager 1125, a network DRX/DTX manager 1130, a BWP switching manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The BWP configuration manager 1125 is capable of, configured to, or operable to support a means for transmitting, to a UE, first control signaling indicating a set of multiple BWPs for the UE. The network DRX/DTX manager 1130 is capable of, configured to, or operable to support a means for transmitting, to the UE, second control signaling indicating at least one of a DTX cycle for the network entity or a DRX cycle for the network entity. The BWP switching manager 1135 is capable of, configured to, or operable to support a means for switching an active BWP for communication between the network entity and the UE from a first BWP of the set of multiple BWPs to a second BWP of the set of multiple BWPs based on the network entity entering the DTX cycle or the DRX cycle in accordance with the second control signaling.

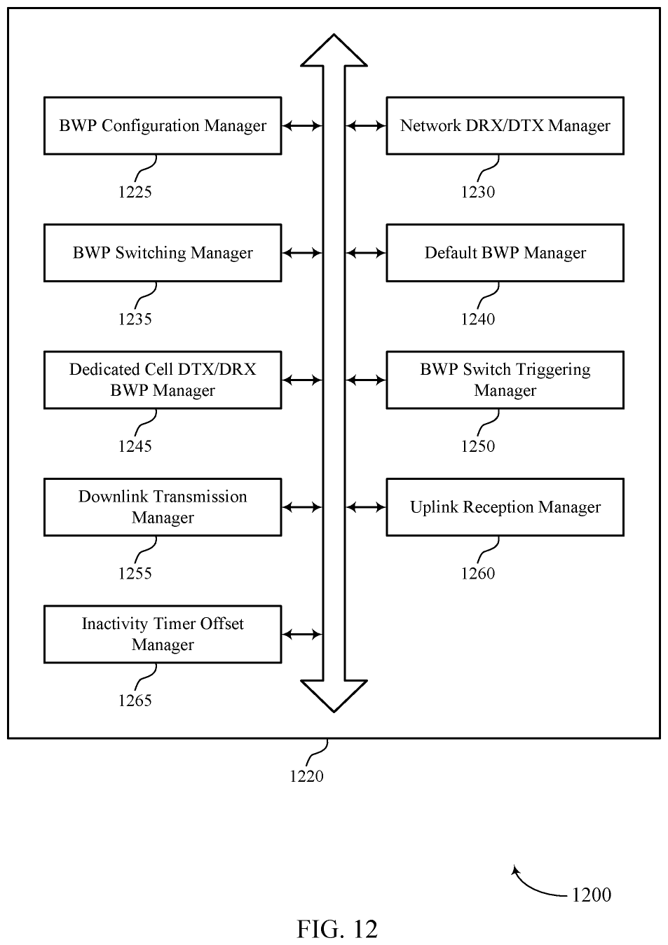

FIG. 12 shows a block diagram 1200 of a communications manager 1220 that supports techniques for BWP interaction with cell DRX and cell DTX in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for BWP interaction with cell DRX and cell DTX as described herein. For example, the communications manager 1220 may include a BWP configuration manager 1225, a network DRX/DTX manager 1230, a BWP switching manager 1235, a default BWP manager 1240, a dedicated cell DTX/DRX BWP manager 1245, a BWP switch triggering manager 1250, a downlink transmission manager 1255, an uplink reception manager 1260, an inactivity timer offset manager 1265, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The BWP configuration manager 1225 is capable of, configured to, or operable to support a means for transmitting, to a UE, first control signaling indicating a set of multiple BWPs for the UE. The network DRX/DTX manager 1230 is capable of, configured to, or operable to support a means for transmitting, to the UE, second control signaling indicating at least one of a DTX cycle for the network entity or a DRX cycle for the network entity. The BWP switching manager 1235 is capable of, configured to, or operable to support a means for switching an active BWP for communication between the network entity and the UE from a first BWP of the set of multiple BWPs to a second BWP of the set of multiple BWPs based on the network entity entering the DTX cycle or the DRX cycle in accordance with the second control signaling.

In some examples, the default BWP manager 1240 is capable of, configured to, or operable to support a means for transmitting, with the first control signaling, an indication of a default BWP, where the second BWP is the default BWP.

In some examples, the dedicated cell DTX/DRX BWP manager 1245 is capable of, configured to, or operable to support a means for transmitting, with the first control signaling or the second control signaling, an indication that the second BWP is associated with the at least one of the DTX cycle or the DRX cycle.

In some examples, the BWP switch triggering manager 1250 is capable of, configured to, or operable to support a means for transmitting, to the UE, third control signaling indicating a triggering condition for switching the active BWP, where switching the active BWP is based on the DTX cycle or the DRX cycle satisfying the triggering condition.

In some examples, the triggering condition includes at least one of a first duration between active periods of the DTX cycle or a second duration between active periods of the DRX cycle.

In some examples, the BWP switching manager 1235 is capable of, configured to, or operable to support a means for switching the active BWP from the second BWP to the first BWP based on the network entity entering an active period of the DTX cycle or the DRX cycle in accordance with the second control signaling, where switching the active BWP from the first BWP to the second BWP based on the network entity entering the DTX cycle or the DRX cycle includes switching the active BWP from the first BWP to the second BWP based on the network entity entering an inactive period of the DTX cycle or the DRX cycle in accordance with the second control signaling.

In some examples, the BWP configuration manager 1225 is capable of, configured to, or operable to support a means for transmitting, with the first control signaling or the second control signaling, an indication that the second BWP is associated with the DTX cycle and that a third BWP of the set of multiple BWPs is associated with the DRX cycle. In some examples, the downlink transmission manager 1255 is capable of, configured to, or operable to support a means for transmitting downlink signaling to the UE in the second BWP during the DTX cycle. In some examples, the uplink reception manager 1260 is capable of, configured to, or operable to support a means for receiving uplink signaling from the UE in the third BWP during the DRX cycle.

In some examples, the inactivity timer offset manager 1265 is capable of, configured to, or operable to support a means for transmitting, to the UE, third control signaling indicating a period of time after the network entity enters the DTX cycle or the DRX cycle for initiation of an inactivity timer at the UE.

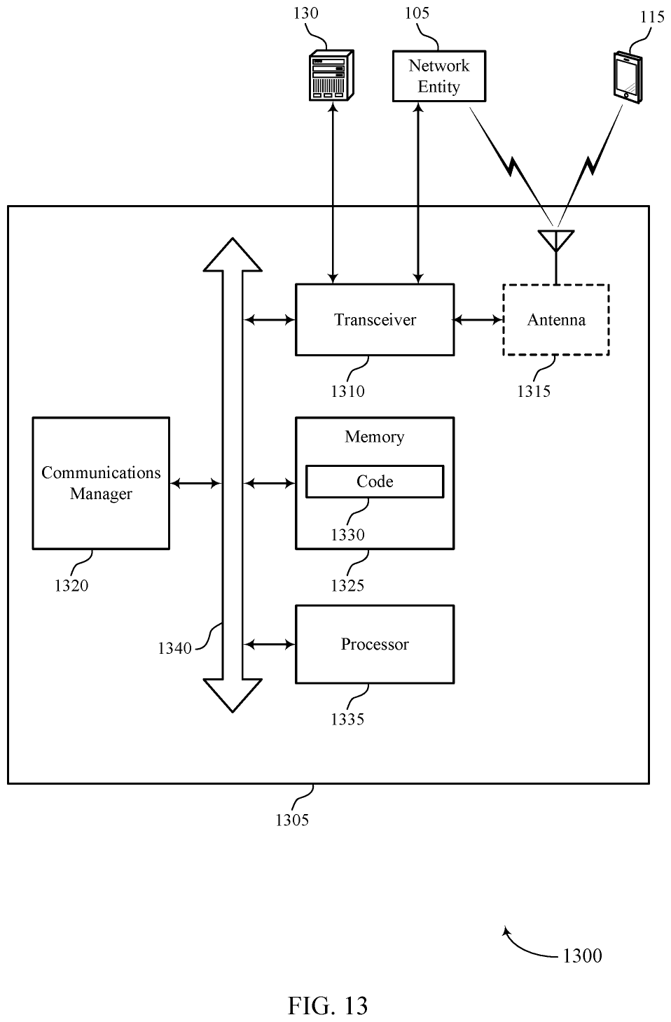

FIG. 13 shows a diagram of a system 1300 including a device 1305 that supports techniques for BWP interaction with cell DRX and cell DTX in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for BWP interaction with cell DRX and cell DTX). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 is capable of, configured to, or operable to support a means for transmitting, to a UE, first control signaling indicating a set of multiple BWPs for the UE. The communications manager 1320 is capable of, configured to, or operable to support a means for transmitting, to the UE, second control signaling indicating at least one of a DTX cycle for the network entity or a DRX cycle for the network entity. The communications manager 1320 is capable of, configured to, or operable to support a means for switching an active BWP for communication between the network entity and the UE from a first BWP of the set of multiple BWPs to a second BWP of the set of multiple BWPs based on the network entity entering the DTX cycle or the DRX cycle in accordance with the second control signaling.

By including or configuring the communications manager 1320 in accordance with examples as described herein, the device 1305 may support techniques for reduced power consumption, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of techniques for BWP interaction with cell DRX and cell DTX as described herein, or the processor 1335 and the memory 1325 may be otherwise configured to perform or support such operations.

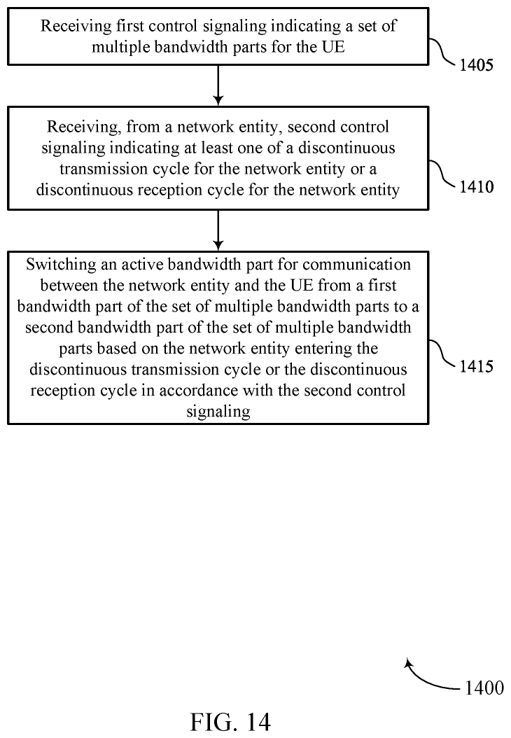

FIG. 14 shows a flowchart illustrating a method 1400 that supports techniques for BWP interaction with cell DRX and cell DTX in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving first control signaling indicating a set of multiple BWPs for the UE. The operations of block 1405 may be performed in accordance with examples as disclosed herein. In some examples, aspects of the operations of 1405 may be performed by a BWP configuration manager 825 as described with reference to FIG. 8.

At 1410, the method may include receiving, from a network entity, second control signaling indicating at least one of a DTX cycle for the network entity or a DRX cycle for the network entity. The operations of block 1410 may be performed in accordance with examples as disclosed herein. In some examples, aspects of the operations of 1410 may be performed by a network DRX/DTX manager 830 as described with reference to FIG. 8.

At 1415, the method may include switching an active BWP for communication between the network entity and the UE from a first BWP of the set of multiple BWPs to a second BWP of the set of multiple BWPs based on the network entity entering the DTX cycle or the DRX cycle in accordance with the second control signaling. The operations of block 1415 may be performed in accordance with examples as disclosed herein. In some examples, aspects of the operations of 1415 may be performed by a BWP switching manager 835 as described with reference to FIG. 8.

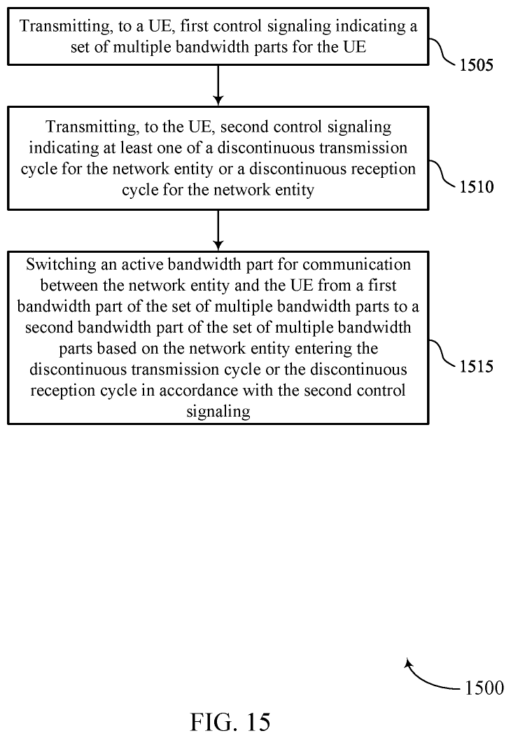

FIG. 15 shows a flowchart illustrating a method 1500 that supports techniques for BWP interaction with cell DRX and cell DTX in accordance with aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, to a UE, first control signaling indicating a set of multiple BWPs for the UE. The operations of block 1505 may be performed in accordance with examples as disclosed herein. In some examples, aspects of the operations of 1505 may be performed by a BWP configuration manager 1225 as described with reference to FIG. 12.

At 1510, the method may include transmitting, to the UE, second control signaling indicating at least one of a DTX cycle for the network entity or a DRX cycle for the network entity. The operations of block 1510 may be performed in accordance with examples as disclosed herein. In some examples, aspects of the operations of 1510 may be performed by a network DRX/DTX manager 1230 as described with reference to FIG. 12.

At 1515, the method may include switching an active BWP for communication between the network entity and the UE from a first BWP of the set of multiple BWPs to a second BWP of the set of multiple BWPs based on the network entity entering the DTX cycle or the DRX cycle in accordance with the second control signaling. The operations of block 1515 may be performed in accordance with examples as disclosed herein. In some examples, aspects of the operations of 1515 may be performed by a BWP switching manager 1235 as described with reference to FIG. 12.

The following provides an overview of aspects of the present disclosure:

Aspect 1: A method for wireless communications at UE, comprising: receiving first control signaling indicating a plurality of BWPs for the UE; receiving, from a network entity, second control signaling indicating at least one of a DTX cycle for the network entity or a DRX cycle for the network entity; and switching an active BWP for communication between the network entity and the UE from a first BWP of the plurality of BWPs to a second BWP of the plurality of BWPs based at least in part on the network entity entering the DTX cycle or the DRX cycle in accordance with the second control signaling.

Aspect 2: The method of aspect 1, further comprising: receiving, with the first control signaling, an indication of a default BWP, wherein the second BWP is the default BWP.

Aspect 3: The method of any of aspects 1 through 2, further comprising: receiving, with the first control signaling or the second control signaling, an indication that the second BWP is associated with the at least one of the DTX cycle or the DRX cycle.

Aspect 4: The method of any of aspects 1 through 3, further comprising: receiving third control signaling indicating a triggering condition for switching the active BWP, wherein switching the active BWP is based at least in part on the DTX cycle or the DRX cycle satisfying the triggering condition.

Aspect 5: The method of aspect 4, wherein the triggering condition comprises at least one of a first duration between active periods of the DTX cycle or a second duration between active periods of the DRX cycle.

Aspect 6: The method of any of aspects 1 through 5, further comprising: switching the active BWP from the second BWP to the first BWP based at least in part on the network entity entering an active period of the DTX cycle or the DRX cycle in accordance with the second control signaling, wherein switching the active BWP from the first BWP to the second BWP based at least in part on the network entity entering the DTX cycle or the DRX cycle comprises switching the active BWP from the first BWP to the second BWP based at least in part on the network entity entering an inactive period of the DTX cycle or the DRX cycle in accordance with the second control signaling.

Aspect 7: The method of any of aspects 1 through 6, further comprising: receiving, with the first control signaling or the second control signaling, an indication that the second BWP is associated with the DTX cycle and that a third BWP of the plurality of BWPs is associated with the DRX cycle; monitoring for downlink signaling from the network entity in the second BWP during the DTX cycle; and transmitting uplink signaling to the network entity in the third BWP during the DRX cycle.

Aspect 8: The method of any of aspects 1 through 7, wherein switching the active BWP further comprises: switching the active BWP based at least in part on an inactivity timer satisfying a threshold.

Aspect 9: The method of aspect 8, further comprising: running the inactivity timer during an active period of the DTX cycle or the DRX cycle; and pausing the inactivity timer during an inactive period of the DTX cycle or the DRX cycle.

Aspect 10: The method of aspect 9, wherein pausing the inactivity timer comprises: pausing the inactivity timer during the inactive period based at least in part on the inactive period satisfying a threshold duration.

Aspect 11: The method of any of aspects 8 through 10, further comprising: starting the inactivity timer a period of time after the network entity enters the DTX cycle or the DRX cycle.

Aspect 12: The method of aspect 11, further comprising: receiving third control signaling indicating the period of time.

Aspect 13: A method for wireless communications at a network entity, comprising: transmitting, to a UE, first control signaling indicating a plurality of BWPs for the UE; transmitting, to the UE, second control signaling indicating at least one of a DTX cycle for the network entity or a DRX cycle for the network entity; and switching an active BWP for communication between the network entity and the UE from a first BWP of the plurality of BWPs to a second BWP of the plurality of BWPs based at least in part on the network entity entering the DTX cycle or the DRX cycle in accordance with the second control signaling.

Aspect 14: The method of aspect 13, further comprising: transmitting, with the first control signaling, an indication of a default BWP, wherein the second BWP is the default BWP.

Aspect 15: The method of any of aspects 13 through 14, further comprising: transmitting, with the first control signaling or the second control signaling, an indication that the second BWP is associated with the at least one of the DTX cycle or the DRX cycle.

Aspect 16: The method of any of aspects 13 through 15, further comprising: transmitting, to the UE, third control signaling indicating a triggering condition for switching the active BWP, wherein switching the active BWP is based at least in part on the DTX cycle or the DRX cycle satisfying the triggering condition.

Aspect 17: The method of aspect 16, wherein the triggering condition comprises at least one of a first duration between active periods of the DTX cycle or a second duration between active periods of the DRX cycle.

Aspect 18: The method of any of aspects 13 through 17, further comprising: switching the active BWP from the second BWP to the first BWP based at least in part on the network entity entering an active period of the DTX cycle or the DRX cycle in accordance with the second control signaling, wherein switching the active BWP from the first BWP to the second BWP based at least in part on the network entity entering the DTX cycle or the DRX cycle comprises switching the active BWP from the first BWP to the second BWP based at least in part on the network entity entering an inactive period of the DTX cycle or the DRX cycle in accordance with the second control signaling.

Aspect 19: The method of any of aspects 13 through 18, further comprising: transmitting, with the first control signaling or the second control signaling, an indication that the second BWP is associated with the DTX cycle and that a third BWP of the plurality of BWPs is associated with the DRX cycle; transmitting downlink signaling to the UE in the second BWP during the DTX cycle; and receiving uplink signaling from the UE in the third BWP during the DRX cycle.

Aspect 20: The method of any of aspects 13 through 19, further comprising: transmitting, to the UE, third control signaling indicating a period of time after the network entity enters the DTX cycle or the DRX cycle for initiation of an inactivity timer at the UE.

Aspect 21: An apparatus for wireless communications at UE, comprising a processor; memory coupled with the processor; and instructions stored in the memory and executable by the processor to cause the apparatus to perform a method of any of aspects 1 through 12.

Aspect 22: An apparatus for wireless communications at UE, comprising at least one means for performing a method of any of aspects 1 through 12.

Aspect 23: A non-transitory computer-readable medium storing code for wireless communications at UE, the code comprising instructions executable by a processor to perform a method of any of aspects 1 through 12.

Aspect 24: An apparatus for wireless communications at a network entity, comprising a processor; memory coupled with the processor; and instructions stored in the memory and executable by the processor to cause the apparatus to perform a method of any of aspects 13 through 20.

Aspect 25: An apparatus for wireless communications at a network entity, comprising at least one means for performing a method of any of aspects 13 through 20.

Aspect 26: A non-transitory computer-readable medium storing code for wireless communications at a network entity, the code comprising instructions executable by a processor to perform a method of any of aspects 13 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at user equipment (UE), comprising:
receiving first control signaling indicating a plurality of bandwidth parts for the UE;
receiving, from a network entity, second control signaling indicating at least one of a discontinuous transmission cycle for the network entity or a discontinuous reception cycle for the network entity; and
switching an active bandwidth part for communication between the network entity and the UE from a first bandwidth part of the plurality of bandwidth parts to a second bandwidth part of the plurality of bandwidth parts based at least in part on the network entity entering the discontinuous transmission cycle or the discontinuous reception cycle in accordance with the second control signaling.

2. The method of claim 1, further comprising:
receiving, with the first control signaling, an indication of a default bandwidth part, wherein the second bandwidth part is the default bandwidth part.

3. The method of claim 1, further comprising:
receiving, with the first control signaling or the second control signaling, an indication that the second bandwidth part is associated with the at least one of the discontinuous transmission cycle or the discontinuous reception cycle.

4. The method of claim 1, further comprising:
receiving third control signaling indicating a triggering condition for switching the active bandwidth part, wherein switching the active bandwidth part is based at least in part on the discontinuous transmission cycle or the discontinuous reception cycle satisfying the triggering condition.

5. The method of claim 4, wherein the triggering condition comprises at least one of a first duration between active periods of the discontinuous transmission cycle or a second duration between active periods of the discontinuous reception cycle.

6. The method of claim 1, further comprising:
switching the active bandwidth part from the second bandwidth part to the first bandwidth part based at least in part on the network entity entering an active period of the discontinuous transmission cycle or the discontinuous reception cycle in accordance with the second control signaling, wherein switching the active bandwidth part from the first bandwidth part to the second bandwidth part based at least in part on the network entity entering the discontinuous transmission cycle or the discontinuous reception cycle comprises switching the active bandwidth part from the first bandwidth part to the second bandwidth part based at least in part on the network entity entering an inactive period of the discontinuous transmission cycle or the discontinuous reception cycle in accordance with the second control signaling.

7. The method of claim 1, further comprising:
receiving, with the first control signaling or the second control signaling, an indication that the second bandwidth part is associated with the discontinuous transmission cycle and that a third bandwidth part of the plurality of bandwidth parts is associated with the discontinuous reception cycle;
monitoring for downlink signaling from the network entity in the second bandwidth part during the discontinuous transmission cycle; and
transmitting uplink signaling to the network entity in the third bandwidth part during the discontinuous reception cycle.

8. The method of claim 1, wherein switching the active bandwidth part further comprises:
switching the active bandwidth part based at least in part on an inactivity timer satisfying a threshold.

9. The method of claim 8, further comprising:
running the inactivity timer during an active period of the discontinuous transmission cycle or the discontinuous reception cycle; and
pausing the inactivity timer during an inactive period of the discontinuous transmission cycle or the discontinuous reception cycle.

10. The method of claim 9, wherein pausing the inactivity timer comprises:
pausing the inactivity timer during the inactive period based at least in part on the inactive period satisfying a threshold duration.

11. The method of claim 8, further comprising:
starting the inactivity timer a period of time after the network entity enters the discontinuous transmission cycle or the discontinuous reception cycle.

12. The method of claim 11, further comprising:
receiving third control signaling indicating the period of time.

13. A method for wireless communications at a network entity, comprising:
transmitting, to a user equipment (UE), first control signaling indicating a plurality of bandwidth parts for the UE;
transmitting, to the UE, second control signaling indicating at least one of a discontinuous transmission cycle for the network entity or a discontinuous reception cycle for the network entity; and
switching an active bandwidth part for communication between the network entity and the UE from a first bandwidth part of the plurality of bandwidth parts to a second bandwidth part of the plurality of bandwidth parts based at least in part on the network entity entering the discontinuous transmission cycle or the discontinuous reception cycle in accordance with the second control signaling.

14. The method of claim 13, further comprising:
transmitting, with the first control signaling, an indication of a default bandwidth part, wherein the second bandwidth part is the default bandwidth part.

15. The method of claim 13, further comprising:
transmitting, with the first control signaling or the second control signaling, an indication that the second bandwidth part is associated with the at least one of the discontinuous transmission cycle or the discontinuous reception cycle.

16. The method of claim 13, further comprising:
transmitting, to the UE, third control signaling indicating a triggering condition for switching the active bandwidth part, wherein switching the active bandwidth part is based at least in part on the discontinuous transmission cycle or the discontinuous reception cycle satisfying the triggering condition.

17. The method of claim 16, wherein the triggering condition comprises at least one of a first duration between active periods of the discontinuous transmission cycle or a second duration between active periods of the discontinuous reception cycle.

18. The method of claim 13, further comprising:
switching the active bandwidth part from the second bandwidth part to the first bandwidth part based at least in part on the network entity entering an active period of the discontinuous transmission cycle or the discontinuous reception cycle in accordance with the second control signaling, wherein switching the active bandwidth part from the first bandwidth part to the second bandwidth part based at least in part on the network entity entering the discontinuous transmission cycle or the discontinuous reception cycle comprises switching the active bandwidth part from the first bandwidth part to the second bandwidth part based at least in part on the network entity entering an inactive period of the discontinuous transmission cycle or the discontinuous reception cycle in accordance with the second control signaling.

19. The method of claim 13, further comprising:
transmitting, with the first control signaling or the second control signaling, an indication that the second bandwidth part is associated with the discontinuous transmission cycle and that a third bandwidth part of the plurality of bandwidth parts is associated with the discontinuous reception cycle;
transmitting downlink signaling to the UE in the second bandwidth part during the discontinuous transmission cycle; and
receiving uplink signaling from the UE in the third bandwidth part during the discontinuous reception cycle.

20. The method of claim 13, further comprising:
transmitting, to the UE, third control signaling indicating a period of time after the network entity enters the discontinuous transmission cycle or the discontinuous reception cycle for initiation of an inactivity timer at the UE.

21. An apparatus for wireless communications at user equipment (UE), comprising:
a processor;
memory coupled with the processor; and
instructions stored in the memory and executable by the processor to cause the apparatus to:
receive first control signaling indicating a plurality of bandwidth parts for the UE;
receive, from a network entity, second control signaling indicating at least one of a discontinuous transmission cycle for the network entity or a discontinuous reception cycle for the network entity; and
switch an active bandwidth part for communication between the network entity and the UE from a first bandwidth part of the plurality of bandwidth parts to a second bandwidth part of the plurality of bandwidth parts based at least in part on the network entity entering the discontinuous transmission cycle or the discontinuous reception cycle in accordance with the second control signaling.

22. The apparatus of claim 21, wherein the instructions are further executable by the processor to cause the apparatus to:
receive, with the first control signaling, an indication of a default bandwidth part, wherein the second bandwidth part is the default bandwidth part.

23. The apparatus of claim 21, wherein the instructions are further executable by the processor to cause the apparatus to:
receive, with the first control signaling or the second control signaling, an indication that the second bandwidth part is associated with the at least one of the discontinuous transmission cycle or the discontinuous reception cycle.

24. The apparatus of claim 21, wherein the instructions are further executable by the processor to cause the apparatus to:
receive third control signaling indicating a triggering condition for switching the active bandwidth part, wherein switching the active bandwidth part is based at least in part on the discontinuous transmission cycle or the discontinuous reception cycle satisfying the triggering condition.

25. The apparatus of claim 24, wherein the triggering condition comprises at least one of a first duration between active periods of the discontinuous transmission cycle or a second duration between active periods of the discontinuous reception cycle.

26. The apparatus of claim 21, wherein the instructions are further executable by the processor to cause the apparatus to:
switch the active bandwidth part from the second bandwidth part to the first bandwidth part based at least in part on the network entity entering an active period of the discontinuous transmission cycle or the discontinuous reception cycle in accordance with the second control signaling, wherein switching the active bandwidth part from the first bandwidth part to the second bandwidth part based at least in part on the network entity entering the discontinuous transmission cycle or the discontinuous reception cycle comprises switching the active bandwidth part from the first bandwidth part to the second bandwidth part based at least in part on the network entity entering an inactive period of the discontinuous transmission cycle or the discontinuous reception cycle in accordance with the second control signaling.

27. The apparatus of claim 21, wherein the instructions are further executable by the processor to cause the apparatus to:
receive, with the first control signaling or the second control signaling, an indication that the second bandwidth part is associated with the discontinuous transmission cycle and that a third bandwidth part of the plurality of bandwidth parts is associated with the discontinuous reception cycle;
monitor for downlink signaling from the network entity in the second bandwidth part during the discontinuous transmission cycle; and
transmit uplink signaling to the network entity in the third bandwidth part during the discontinuous reception cycle.

28. The apparatus of claim 21, wherein the instructions to switch the active bandwidth part are further executable by the processor to cause the apparatus to:
switch the active bandwidth part based at least in part on an inactivity timer satisfying a threshold.

29. The apparatus of claim 28, wherein the instructions are further executable by the processor to cause the apparatus to:
run the inactivity timer during an active period of the discontinuous transmission cycle or the discontinuous reception cycle; and
pause the inactivity timer during an inactive period of the discontinuous transmission cycle or the discontinuous reception cycle.

30. An apparatus for wireless communications at a network entity, comprising:
a processor;
memory coupled with the processor; and
instructions stored in the memory and executable by the processor to cause the apparatus to:
transmit, to a user equipment (UE), first control signaling indicating a plurality of bandwidth parts for the UE;
transmit, to the UE, second control signaling indicating at least one of a discontinuous transmission cycle for the network entity or a discontinuous reception cycle for the network entity; and
switch an active bandwidth part for communication between the network entity and the UE from a first bandwidth part of the plurality of bandwidth parts to a second bandwidth part of the plurality of bandwidth parts based at least in part on the network entity entering the discontinuous transmission cycle or the discontinuous reception cycle in accordance with the second control signaling.
